(19) United States
(12) Patent Application Publication
(10) Pub. No.: US 2011/0086214 A1
(43) Pub. Date: Apr. 14, 2011

(54) BUILDING PRODUCTS CONSTRUCTED FROM THERMOPLASTIC POLYMER MAT IMPREGNATED WTIH CEMENTITIOUS MATERIAL

(76) Inventor: Anthony L. Rockwell, Pickerington, OH (US)

(21) Appl. No.: 12/576,446

(22) Filed: Oct. 9, 2009

(51) Int. Cl. B32B 13/02; B32B 27/32; B32B 27/36; B32B 27/40; B32B 27/06; B32B 17/04; B32B 13/00; B05D 3/02

(52) U.S. Cl. 428/294.7; 428/500; 428/480; 428/423.1; 428/425.6; 428/441; 428/442; 428/337; 427/372.2

(57) ABSTRACT

A building product includes a thermoplastic polymer mat impregnated with a cementitious material. The thermoplastic polymer mat has a front face and a rear face. A stiffening layer is laminated to the rear face of the thermoplastic polymer mat. A finishing layer covers the front face of the thermoplastic polymer mat. A method of producing the building product is also provided.

### TECHNICAL FIELD AND INDUSTRIAL APPLICABILITY OF THE INVENTION

The present invention relates generally to the building product field and, more particularly, to building products constructed from thermoplastic polymer mat impregnated with cementitious material as well as to methods for making the same.

### BACKGROUND OF THE INVENTION

Building products constructed from polymer mats and cementitious materials are well known in the art. For example, U.S. Pat. No. 5,772,846 discloses a non-woven fibrous mat used for facing a gypsum board as well as a method of making the same. The mat preferably contains a major portion of glass fibers and a minor portion of polyester fibers bound together.

Published United States patent application no. 2008/0190062 discloses a fibrous mat-faced cementitious article or building product including a cementitious core and a fibrous mat of polymer or mineral fibers. The fibrous mat includes a hydrophobic finish on at least one surface thereof that is contacted with the cementitious core. The hydrophobic finish prevents, to at least some degree, the fibrous mat from becoming imbedded in the cementitious core during production.

The present invention relates to new and improved building products such as wall panels, ceiling panels, ceiling tiles, siding, decorative moldings, roofing, shingles and the like constructed from thermoplastic polymer mat impregnated with cementitious material. Advantageously, the building products are not only aesthetically pleasing but are inexpensive to produce via an inline manufacturing process. The building products possess a number of beneficial characteristics including light weight, high strength, minimal friability and good stiffness so as to be easily handled even when provided in long lengths. Further, the building products provide beneficial acoustic and thermal insulation performance.

### SUMMARY OF THE INVENTION

In accordance with the purposes of the present invention as described herein, an improved building product is provided. The building product comprises a thermoplastic polymer mat impregnated with a cementitious material. The thermoplastic polymer mat has a front face and a rear face. In addition the building product includes a stiffening layer laminated to the rear face of the thermoplastic polymer mat and a finishing layer covering the front face of the thermoplastic polymer mat.

In one particularly useful embodiment, the thermoplastic polymer mat has a loft or thickness of between about 0.25 to about 4.0 inches and a density of between about 0.6 to about 4.0 pounds per cubic foot prior to impregnation. In addition, the thermoplastic polymer mat includes an open weave structure to allow the cementitious material to penetrate the mat and coat the fibers thereof through greater than 50% of the thickness of the mat. The thermoplastic mat then returns to at least 70% of its original thickness after impregnation.

In accordance with yet another aspect of the present invention, a method is provided for producing a building product. The method may be broadly defined as comprising the steps of: (a) impregnating a thermoplastic polymer mat with a cementitious material, (b) drying the impregnated polymer mat, (c) stiffening the impregnated polymer mat by adding a stiffening layer to a rear face of the impregnated polymer mat and (d) adding a finishing layer over a front face of the impregnated thermoplastic polymer mat. This is followed by drying the finishing layer.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1a is a side elevational view illustrating a first embodiment of the building product of the present invention;

FIG. 1b is a side elevations view illustrating a second embodiment of the building product of the present invention; and

FIG. 2 is a schematical diagram illustrating a method of inline production of the building product illustrated in FIG. 1.

Reference will now be made in detail to the present preferred embodiment of the invention, examples of which are illustrated in the accompanying drawings.

### DETAILED DESCRIPTION OF THE PREFERRED EMBODIMENTS OF THE INVENTION

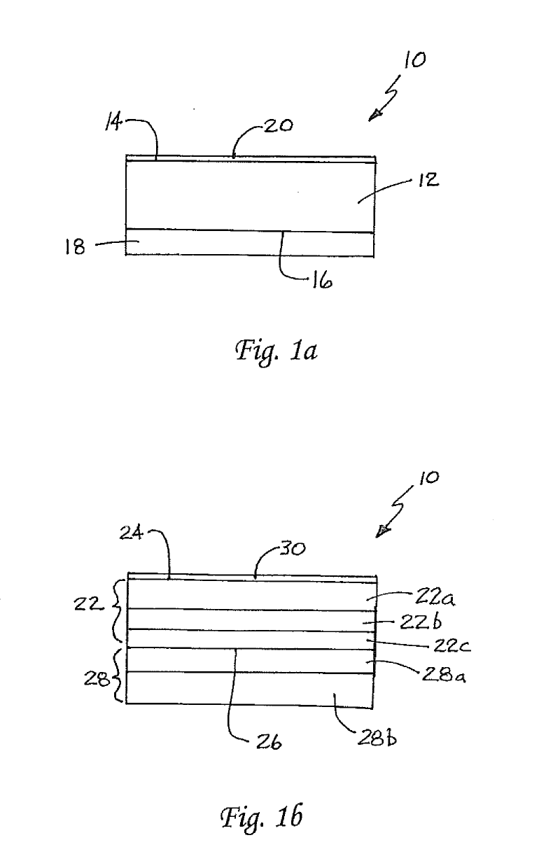

Reference is now made to FIG. 1a illustrating one possible embodiment of the building product 10 of the present invention. The building product 10 may, for example, take the form of a wall panel, a ceiling panel, a ceiling tile, siding, a decorative molding, roofing, a shingle or the like.

As illustrated, the building product 10 includes a thermoplastic polymer mat 12 impregnated with a cementitious material. The thermoplastic polymer mat 12 includes a front face 14 and a rear face 16. A stiffening layer 18 is laminated to the rear face 16 of the thermoplastic polymer mat 12. A finishing layer 20 covers the front face 14 of the thermoplastic polymer mat 12.

In an alternative embodiment illustrated in FIG. 1b, the building product 10 comprises a thermoplastic mat 22 including multiple layers 22a, 22b, 22c of thermoplastic polymer mat material that have been laminated together. The thermoplastic mat 22 includes a front face 24 and rear face 26. A stiffening layer 28 is laminated to the rear face 26. As illustrated, the stiffening layer 28 comprises multiple layers of stiffening material 28a, 28b. A finishing layer 30 covers the front face 24 of the thermoplastic mat 22.

In either of the embodiments illustrated in FIGS. 1a and 1b, the thermoplastic mat 12, 22 is made from a material selected from a group consisting of polyester, polyethylene, polypropylene, polyethylene terephthalate; polybutylene terephthalate, rayon, nylon and mixtures thereof. In one possible embodiment the thermoplastic polymer mat 12, 22 further includes reinforcement fibers. The reinforcement fibers are selected from a group consisting of chopped thermoplastic fibers, a continuous strand of thermoplastic fibers, poltruded thermoplastic fibers, chopped glass fibers, a continuous strand of glass fibers, poltruded glass fibers and mixtures thereof. Where chopped thermoplastic reinforcement fibers are utilized, they have a length of between about 0.5 to about 2.0 inches, a diameter of between about 9 to about 100 microns and are selected from a material consisting of PET, nylon, polypropylene and mixtures thereof. Where chopped glass fibers are utilized for the reinforcement fibers, they have a length of between about 0.5 to about 2.0 inches and a diameter of between about 6 and about 25 microns.

In any of the embodiments, the thermoplastic polymer mat 12, 22 is impregnated with the cementitious material through greater than 50% of the thickness of the mat. In some embodiments the impregnation is through greater than 60% of the thickness of the mat 12, 22. In still other embodiments the impregnation with the cementitious material is through greater than 70% of the thickness of the thermoplastic polymer mat 12, 22. In still other embodiments the impregnation with the cementitious material is through greater than 80% of the thickness of the thermoplastic polymer mat 12, 22. In still other embodiments the impregnation with the cementitious material is through greater than 90% of the thickness of the thermoplastic polymer mat 12, 22. In still other embodiments the impregnation with the cementitious material is through approximately 100% of the thickness of the thermoplastic polymer mat 12, 22. The amount of desired impregnation is determined by the final application of the building product.

The cementitious material is selected from a group consisting of concrete, gypsum, plaster, plaster of paris, an elastomeric slurry, a latex, an epoxy, a plastic, spray polypropylene, spray polyurethane and mixtures thereof. Further describing the invention, the stiffening layer 18, 28 is selected from a group of material consisting of a fiberglass mat, a polyester mat, a PET/glass combination mat, a perforated solid mat made from polypropylene, a perforated polymer film and combinations thereof treated with a material selected from a group consisting of concrete, gypsum, plaster, plaster of paris, an elastomeric slurry, a latex, an epoxy, a plastic, a spray polypropylene, a spray polyurethane and mixtures thereof prior to laminating to the impregnated thermoplastic polymer mat 12, 22. The finishing layer 20, 30 is made from a material selected from a group consisting of a veil, glass roving, strips of veil, concrete, gypsum, plaster, plaster of paris, an elastomeric slurry, a latex, an epoxy, a plastic, a spray polypropylene, a spray polyurethane, a paint and mixtures thereof.

The thermoplastic polymer mat 12, 22 has significant loft and is adapted for molding into any desired shape. In one particularly useful embodiment the thermoplastic polymer mat 12, 22, prior to impregnation, has a thickness of between about 0.25 to about 4.0 inches and a density of between about 0.6 to about 4.0 pounds per cubic foot. The thermoplastic polymer mat 12, 22 further includes an open weave structure to allow penetration of cementitious material to coat the fibers in the mat. Further, the thermoplastic polymer mat 12, 22 has significant resiliency returning to at least 70% of its original thickness after compression in order to impregnate the thermoplastic polymer mat 12, 22 with the cementitious material.

The building product 10 of the present invention is produced by a unique and novel method that will now be described in detail. The method may be broadly described as comprising the steps of impregnating the thermoplastic polymer mat 12, 22 with a cementitious material, drying the thermoplastic polymer mat, stiffening the impregnated thermoplastice polymer mat by adding a stiffening layer 18, 28 to a rear face 16,26 of the impregnated thermoplastic polymer mat, adding a finishing layer 20, 30 over a front face 14, 24 of the impregnated thermoplastic polymer mat and drying the finishing layer. In one particularly useful embodiment the method includes the step of molding at least a front face 14, 24 of the thermoplastic polymer mat 12, 22 into a desired shape prior to impregnating. Thus, the building product may be molded to take on substantially any shape desired for use as a wall panel, a ceiling panel, a ceiling tile, siding, a decorative molding, roofing, a shingle such as a dimensional shingle or a shake shingle or the like.

The method includes using a thermoplastic polymer mat 12, 22 made from a material selected from a group consisting of polyester, polyethylene, polypropylene, polyethylene terephthalate, polybutylene terephthalate, rayon, nylon and mixtures thereof either alone or in combination with reinforcement fibers. The method also includes using a cementitious material consisting of concrete, gypsum, plaster, plaster of paris, an elastomeric slurry, a latex, an epoxy, a plastic, spray polypropylene, spray polyurethane and mixtures thereof.

More specifically describing the method, the impregnating step includes coating the thermoplastic polymer mat 12, 22 with the cementitious material and then compressing the coated thermoplastic polymer mat so as to force cementitious material through greater than 50% of the thickness of the coated thermoplastic polymer mat. In other embodiments and particular applications the thermoplastic polymer mat 12, 22 is impregnated with the cementitious material through greater than 60%, 70%, 80%, 90% and in one possible embodiment approximately 100% of the thickness of the coated thermoplastic polymer mat 12, 22. In one possible embodiment the compression is performed by using pressure rollers to squeeze the cementitious material into the pores and spaces of the thermoplastic polymer mat 12, 22 so as to coat the fibers of the mat.

Still further describing the invention, the method includes selecting the stiffening layer 18, 28 from a group of materials consisting of a fiberglass mat, a polyester mat, a PET/glass combination mat, a perforated solid mat made from polypropylene, a perforated polymer film and combinations thereof. The method further includes treating the stiffening layer with a material selected from a group consisting of concrete, gypsum, plaster, plaster of paris, an elastomeric slurry, a latex, an epoxy, a plastic, a spray polypropylene, a spray polyurethane and mixtures thereof prior to laminating to the impregnated thermoplastic polymer mat 12, 22. Still further the finishing layer 20, 30 is made using a material selected from a group consisting of a woven mat, veil, glass roving, strips of veil, concrete, gypsum, plaster, plaster of paris, an elastomeric slurry, a latex, an epoxy, a plastic, a spray polypropylene, a spray polyurethane, a paint and mixtures thereof. Drying of the impregnated thermoplastic polymer mat 12, 22 and/or the finishing layer 20, 30 may be accomplished using a hot air oven, chemical catalysts or even combinations thereof.

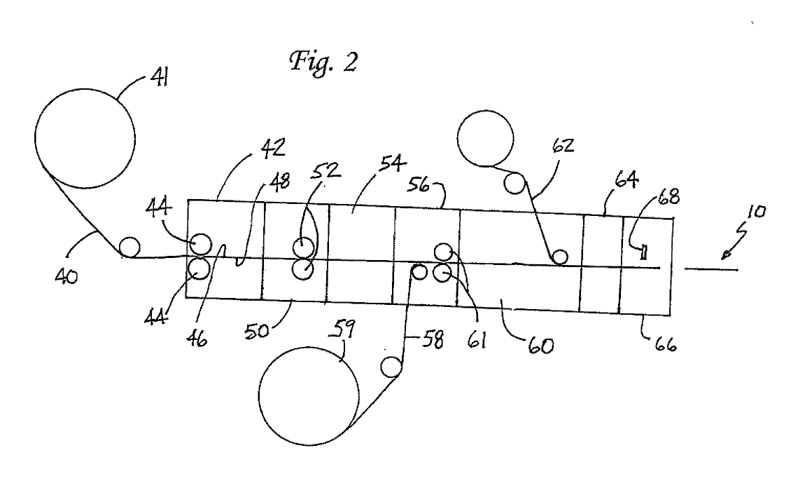

In accordance with yet another aspect of the present invention, the building product 10 may be made in-line in a continuous manufacturing process. More specifically, reference is made to FIG. 2 schematically illustrating this process. As illustrated, a continuous web of thermoplastic polymer mat 40 is fed from a roll 41 into a molding unit 42. The molding unit 42 may be provided with one or more heated pressure rolls 44 to mold at least the front face 46 and for some applications, the rear face 48 of the continuous web of thermoplastic polymer mat 40.

Following molding, the continuous web of thermoplastic polymer mat 40 is fed into the impregnation unit 50. Here cementitious material is applied to at least one face 46, 48 of the continuous web of thermoplastic polymer mat 40. Application of cementitious material may be made by any means known in the art including, but not limited to, dipping the continuous web of thermoplastic polymer mat 40 into a vat of cementitious material, spraying cementitious material onto the mat or applying through a chute with a doctor blade. Following application of the cementitious material, the continuous web of thermoplastic polymer mat 40 is compressed between compression rolls 52 in order to force the cementitious material through the pores and spaces in the continuous web of thermoplastic polymer mat 40 so as to coat the fibers of that mat. Compression is sufficient to impregnate at least 50% of the thickness of the continuous web of thermoplastic polymer mat 40. Depending on the particular application, impregnation may take place to at least 50%, 60%, 70%, 80%, 90% or up to about 100% of the thickness of the continuous web of thermoplastic polymer mat 40. Following impregnation, the continuous web of thermoplastic polymer mat 12,22 returns to at least 70% of its original thickness before it is dried in the drying unit 54. Drying unit 54 may comprise an oven or may simply comprise air drying in the presence of a chemical catalyst. Following drying, the continuous web of thermoplastic polymer mat 40 is fed into a stiffening unit 56.

As illustrated in FIG. 2, a continuous web of stiffening material 58 is fed from a roll 59 into the stiffener unit 56 and the stiffening layer 18,28 is applied to the rear face 48 of the continuous web of thermoplastic polymer mat 40 by means of heated compression rolls 61. The stiffening material 58 and continuous web of thermoplastic polymer mat 40 are laminated together by heat and pressure. In some applications a hot melt adhesive may be utilized to complete or augment the lamination process.

Next, the continuous web of thermoplastic polymer mat 40 including the stiffening layer 18, 28 is fed into the finishing unit 60 where the finishing layer 20, 30 is applied to the front face 46 of the continuous web of thermoplastic polymer mat 40. Where the finishing layer 20, 30 comprises veil or other appropriate material a continuous web of veil 62 is fed into the finishing unit. Alternatively, where the finishing layer comprises, for example, painting, a sprayer unit applies the finishing layer directly to the front face 46 of the continuous web of thermoplastic polymer mat 40. Subsequent to application of the finishing layer 20, 30, the continuous web of thermoplastic polymer mat 40 is fed into a drying unit 64 which serves to dry the finishing layer. The drying unit 64 may, for example, a drying oven. Following drying of the finishing layer 20, 30, the continuous web of thermoplastic polymer mat 40 is fed to a cutting station 66 where the building product 10 is cut to desired length by blade 68 or other means. Advantageously, this in-line production process allows the building product to be manufactured more efficiently reducing both the production time and cost for a given amount of building product.

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A building product, comprising:
a thermoplastic polymer mat impregnated with a cementitious material, said thermoplastic polymer mat having a front face and a rear face;
a stiffening layer laminated to said rear face of said thermoplastic polymer mat; and
a finishing layer covering said front face of said thermoplastic polymer mat.

2. The product of claim 1, wherein said thermoplastic polymer mat is impregnated with said cementitious material through greater than 50% of the thickness of said thermoplastic polymer mat.

3. The product of claim 2, wherein said thermoplastic polymer mat is made from a material selected from a group consisting of polyester, polyethylene, polypropylene, polyethylene terephthalate, polybutylene terephthalate, rayon, nylon and mixtures thereof.

4. The product of claim 3, wherein said cementitious material is selected from a group consisting of concrete, gypsum, plaster, plaster of paris, an elastomeric slurry, a latex, an epoxy, a plastic, spray polypropylene, spray polyurethane and mixtures thereof.

5. The product of claim 4, wherein said stiffening layer is selected from a group of materials consisting of a fiberglass mat, a polyester mat, a PET/glass combination mat, a perforated solid mat made from polypropylene, a perforated polymer film and combinations thereof, treated with a material selected from a group consisting of concrete, gypsum, plaster, plaster of paris, an elastomeric slurry, a latex, an epoxy, a plastic, a spray polypropylene, a spray polyurethane and mixtures thereof prior to laminating to said impregnated thermoplastic polymer mat.

6. The product of claim 5, wherein said finishing layer is made from a material selected from a group consisting of a veil, glass roving, strips of veil, concrete, gypsum, plaster, plaster of paris, an elastomeric slurry, a latex, an epoxy, a plastic, a spray polypropylene, a spray polyurethane, a paint and mixtures thereof.

7. The product of claim 1 wherein said thermoplastic polymer mat comprises multiple layers of thermoplastic polymer mat material.

8. The product of claim 1 wherein said stiffening layer comprises multiple layers of stiffening material.

9. The product of claim 1 wherein said thermoplastic polymer mat prior to impregnation, has a thickness of between about 0.25 to about 4.0 inches, a density of between about 0.6 to about 4.0 pounds per cubic foot, said thermoplastic polymer mat further including an open weave structure to allow penetration of cementitious material to coat fibers in said mat, said thermoplastic polymer mat returning to at least 70% of its original thickness after impregnation.

10. The product of claim 1 wherein said thermoplastic polymer mat further includes reinforcement fibers.

11. The product of claim 10, wherein said reinforcement fibers are selected from a group consisting of thermoplastic fibers, a continuous strand of thermoplastic fibers, poltruded thermoplastic fibers, chopped glass fibers, a continuous strand of glass fibers, poltruded glass fibers, and mixtures thereof.

12. The product of claim 11, wherein said chopped thermoplastic reinforcement fibers have a length of between about 0.5 to about 2.0 inches, a diameter of between about 9 to about 100 microns and are selected from a material consisting of PET, nylon, polypropylene and mixtures thereof.

13. The product of claim 11, wherein said chopped glass fibers have a length of between about 0.5 to about 2.0 inches and a diameter of between about 6 and about 25 microns.

14. The product of claim 1, wherein said thermoplastic polymer mat is impregnated with said cementitious material through greater than 60% of the thickness of said thermoplastic polymer mat.

15. The product of claim 1, wherein said thermoplastic polymer mat is impregnated with said cementitious material through greater than 70% of the thickness of said thermoplastic polymer mat.

16. The product of claim 1, wherein said thermoplastic polymer mat is impregnated with said cementitious material through greater than 80% of the thickness of said thermoplastic polymer mat.

17. The product of claim 1, wherein said thermoplastic polymer mat is impregnated with said cementitious material through greater than 90% of the thickness of said thermoplastic polymer mat.

18. The product of claim 1, wherein said thermoplastic polymer mat is impregnated with said cementitious material through about 100% of the thickness of said thermoplastic polymer mat.

19. A method of producing a building product, comprising:
impregnating said thermoplastic polymer mat with a cementitious material;
drying said impregnated thermoplastic polymer mat;
stiffening said impregnated thermoplastic polymer mat by adding a stiffening layer to a rear face of said impregnated thermoplastic polymer mat;
adding a finishing layer over said front face of said impregnated thermoplastic polymer mat; and
drying said finishing layer.

20. The method of claim 19, including molding at least a front face of a thermoplastic polymer mat into a desired shape prior to impregnating.

21. The method of claim 19, including using a thermoplastic polymer mat made from a material selected from a group consisting of polyester, polyethylene, polypropylene, polyethylene terephthalate, polybutylene terephthalate, rayon, nylon and mixtures thereof alone or in combination with reinforcement fibers.

22. The method of claim 21, including using a cementitious material selected from a group consisting of concrete, gypsum, plaster, plaster of paris, an elastomeric slurry, a latex, an epoxy, a plastic, spray polypropylene, spray polyurethane and mixtures thereof.

23. The method of claim 19, including using a cementitious material selected from a group consisting of concrete, gypsum, plaster, plaster of paris, an elastomeric slurry, a latex, an epoxy, a plastic, spray polypropylene, spray polyurethane and mixtures thereof.

24. The method of claim 19, wherein said impregnating step includes coating said thermoplastic polymer mat with said cementitious material and then compressing said coated thermoplastic polymer mat so as to force cementitious material through greater than 50% of the thickness of said coated thermoplastic polymer mat.

25. The method of claim 24, wherein said compressing is performed by using pressure rollers.

26. The method of claim 24, further including selecting said stiffening layer from a group of materials consisting of a fiberglass mat, a polyester mat, a PET/glass combination mat, a perforated solid mat made from polypropylene, a perforated polymer film and combinations thereof.

27. The method of claim 26, including treating said stiffening layer with a material selected from a group consisting of concrete, gypsum, plaster, plaster of paris, an elastomeric slurry, a latex, an epoxy, a plastic, a spray polypropylene, a spray polyurethane and mixtures thereof prior to laminating to said impregnated thermoplastic polymer mat.

28. The method of claim 24, further including using a material selected from a group consisting of a woven mat, veil, glass roving, strips of veil, concrete, gypsum, plaster, plaster of paris, an elastomeric slurry, a latex, an epoxy, a plastic, a spray polypropylene, a spray polyurethane, a paint and mixtures thereof as said finishing layer.

29. The method of claim 19, including drying using a hot air oven, chemical catalysts and combinations thereof.

30. The method of claim 19, further including using a fiberglass mat for said stiffening layer.

31. The method of claim 30, including treating said fiberglass mat with a material selected from a group consisting of gypsum, plaster, plaster of paris, an elastomeric slurry, a latex, an epoxy, a plastic, a spray polypropylene, a spray polyurethane and mixtures thereof prior to laminating to said impregnated thermoplastic polymer mat.

32. The method of claim 19, further including using a material selected from a group consisting of a veil, glass roving, strips of veil, concrete, gypsum, plaster, plaster of paris, an elastomeric slurry, a latex, an epoxy, a plastic, a spray polypropylene, a spray polyurethane, a paint and mixtures thereof as said finishing layer.

33. The method of claim 19, wherein said thermoplastic polymer mat is a continuous web and completing said molding, impregnating, drying, stiffening, adding and drying steps in-line in a continuous manufacturing process.

34. The method of claim 33, including cutting said product to a desired length.

35. The method of claim 19, including also molding a rear face of said thermoplastic polymer mat before impregnating.
